(19) United States
(12) Patent Application Publication
(10) Pub. No.: US 2018/0127552 A1
(43) Pub. Date: May 10, 2018

(54) Method Of Forming A Gel Having Improved Thermal Stability

(71) Applicant: Dow Corning Corporation, Midland, MI (US)

(72) Inventors: Matt D. Dowland, Midland, MI (US); Daesup Hyun, Kyunggido (KR); John J. Kennan, Midland, MI (US); Kent R. Larson, Midland, MI (US); Randall G. Schmidt, Midland, MI (US); Shengqing Xu, Midland, MI (US)

(21) Appl. No.: 15/861,179

(22) Filed: Jan. 3, 2018

Related U.S. Application Data
(63) Continuation-in-part of application No. 14/349,625, filed on Apr. 3, 2014, now abandoned.
(60) Provisional application No. 61/544,001, filed on Oct. 6, 2011.

(51) Int. Cl. C08J 3/075; C08J 3/20; C08G 77/14

(52) U.S. Cl. CPC C08J 3/075; C08J 3/203; C08G 2220/00; C08J 2383/06; C08G 77/14

(57) ABSTRACT

A gel having improved thermal stability is the hydrosilylation reaction product of (A) an organopolysiloxane having an average of at least 0.1 silicon-bonded alkenyl group per molecule and (B) a cross-linker having an average of at least 2 silicon-bonded hydrogen atoms per molecule. (A) and (B) react via hydrosilylation in the presence of (C) a hydrosilylation catalyst and (D) a heated reaction product of iron acetylacetonate. The iron acetylacetonate is present prior to heating in an amount of from about 0.05 to about 30 weight percent based on a total weight of (A) and (B). The gel is formed using a method that includes the steps of (I) heating the iron acetylacetonate to form the (D) heated reaction product of the iron acetylacetonate and (II) combining (A), (B), (C) and (D) to effect the hydrosilylation reaction of (A) and (B) in the presence of (C) and (D) to form the gel.

### FIELD OF THE DISCLOSURE

The present disclosure generally relates to a method of forming a gel that is a hydrosilylation reaction product having improved thermal stability.

### DESCRIPTION OF THE RELATED ART

Typical silicones have excellent stress-buffering properties, electrical properties, resistance to heat, and weather-proof properties and can be used in many applications. In many applications, silicones can be used to transfer heat away from heat-generating electronic components. However, when used in high performance electronic articles that include electrodes and small electrical wires, typical silicones tend to harden, become brittle, and crack, after exposure to long operating cycles and high heat. The hardening and cracking disrupt or destroy the electrodes and wires thereby causing electrical failure.

U.S. Pat. No. 4,824,903 to Aizawa et al. teaches formation of a heat-resistant polyorganosiloxane composition that is described as a heat-resistant silicone rubber which are known by those of skill in the art to differ from silicone gels. Gels are not reinforced but instead are a loosely and incompletely cross-linked material which are weaker than rubbers. Silicone rubbers, on the other hand, are known by those of skill in the art to be filler reinforced elastomers that include reinforcing fillers such as carbon black, silica, etc. These fillers are used to give the rubbers high elongation and strength. Aizawa confirms the presence of carbon black as a necessary component in the silicone rubber, explains that carbon black must be present, and explains that use of too little carbon black (e.g. less than 3 wt %) makes it difficult to obtain a heat-resistant rubber. The European Tyre and Rubber Manufacturer's Association (ERTMA) also recognizes that amorphous silica and carbon black have been used as reinforcing fillers in the rubber industry for decades.

Accordingly, and in view of the above, there remains an opportunity to develop an improved silicone.

### SUMMARY OF THE DISCLOSURE AND ADVANTAGES

The instant disclosure provides a method of forming a gel that has improved thermal stability. The gel is the hydrosilylation reaction product of (A) an organopolysiloxane having an average of at least 0.1 silicon-bonded alkenyl group per molecule and (B) a cross-linker having an average of at least 2 silicon-bonded hydrogen atoms per molecule. (A) and (B) react via hydrosilylation in the presence of (C) a hydrosilylation catalyst and (D) a heated reaction product of iron acetylacetonate. The iron acetylacetonate is present prior to heating in an amount of from about 0.05 to about 30 weight percent based on a total weight of (A) and (B). The method includes the step of (I) heating the iron acetylacetonate to form the (D) heated reaction product of the iron acetylacetonate. The method also includes the step of (II) combining (A), (B), (C) and (D) to effect the hydrosilylation reaction of (A) and (B) in the presence of (C) and (D) to form the gel.

The (D) heated reaction product allows the gel to maintain low Young's modulus (i.e., low hardness and viscosity) properties even after extensive heat ageing. A gel that has low modulus is less prone to hardening, becoming brittle, and cracking, after exposure to long operating cycles and high heat, decreasing the chance that, when used in an electronic article, any electrodes or wires will be damaged, thereby decreasing the chance that electrical failure will occur.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is an electron micrograph of Fe₂O₃ particles in a silicone fluid wherein the particles are formed from heating iron acetylacetonate in the fluid. These Fe₂O₃ particles are representative of the (D) heated reaction product of iron acetylacetonate used to form Gels 1-6 of the Examples and also used to form samples of Gel 6 in the first series of the Examples.

FIG. 2 is an electron micrograph of Fe₂O₃ particles in a silicone fluid wherein the particles are purchased from Sigma Aldrich, St Louis, Mo. These Fe₂O₃ particles are representative of the “nano-sized” particles used to form comparative samples of Gel 6 of the second series of the Examples.

FIG. 3 is an electron micrograph of Fe₂O₃ particles in a silicone fluid wherein the particles are purchased from Sigma Aldrich. These Fe₂O₃ particles are representative of the “micro-sized” particles used to form comparative samples of Gel 6 of the third series of the Examples.

FIG. 4 is a representative transmission electron micrograph (TEM) image of the (D) heated reaction product of iron acetylacetonate (Fe (acac)) in the form of nanoparticles) dispersed in Gel 4 of the Examples.

### DETAILED DESCRIPTION OF THE DISCLOSURE

The “Summary of the Disclosure and Advantage” and Abstract are incorporated here by reference.

The terminology “hydrosilylation reaction product” describes that (A) and (B) react in a hydrosilylation reaction in the presence of (C) and (D). Typically, (A) and (B) react such that a gel forms and cures, either partially or completely.

### (A) Organopolysiloxane:

The (A) organopolysiloxane may be a single polymer or may include two or more polymers that differ in at least one of the following properties: structure, viscosity, average molecular weight, siloxane units, and sequence. The (A) organopolysiloxane has an average of at least 0.1 silicon-bonded alkenyl group per individual polymer molecule, i.e. there is, on average, at least one silicon-bonded alkenyl group per 10 individual polymer molecules. More typically, the (A) organopolysiloxane has an average of 1 or more silicon-bonded alkenyl groups per molecule. In various embodiments, the (A) organopolysiloxane has an average of at least 2 silicon-bonded alkenyl groups per molecule. The (A) organopolysiloxane may have a molecular structure that is in linear form or branched linear form or in dendrite form. The (A) organopolysiloxane may be or may include a single (type of) polymer, a copolymer, or a combination of two or more polymers. The (A) organopolysiloxane may be further defined as an organoalkylpolysiloxane.

The silicon-bonded alkenyl groups of the (A) organopolysiloxane are not particularly limited but typically are defined as one or more of vinyl, allyl, butenyl, pentenyl, hexenyl, or heptenyl groups. Each alkenyl group may be the same or different and each may be independently selected from all others. Each alkenyl group may be terminal or pendant. It one embodiment, the (A) organopolysiloxane includes both terminal and pendant alkenyl groups.

The (A) organopolysiloxane may also include silicon-bonded organic groups including, but not limited to, monovalent organic groups free of aliphatic unsaturation. These monovalent organic groups may have at least one and as many as 2, 3, 4, 5, 6, 7, 8, 9, 10, 11, 12, 14, 16, 18, and 20 carbon atoms, and are exemplified by, but not limited to, alkyl groups such as methyl, ethyl, and isomers of propyl, butyl, t-butyl, pentyl, hexyl, heptyl, octyl, nonyl, decyl, undecyl, dodecyl, tetradecyl, hexadecyl, octadecyl, and eicosanyl; cycloalkyl groups such as cyclopentyl and cyclohexyl; and aromatic (aryl) groups such as phenyl, tolyl, xylyl, benzyl, and 2-phenylethyl; and 3,3,3,-trifluoropropyl, and similar halogenated alkyl groups. In certain embodiments, the organic groups are methyl or phenyl groups.

The (A) organopolysiloxane may also include terminal groups that may be further defined as alkyl or aryl groups as described above, and/or alkoxy groups exemplified by methoxy, ethoxy, or propoxy groups, or hydroxyl groups.

In various embodiments, the (A) organopolysiloxane may have one of the following formulae:

R¹₂R²SiO(R¹₂SiO)_{d}(R¹R²SiO)ₑSiR¹₂R², Formula (I):

R¹₃ SiO(R¹₂SiO)_{f}(R¹R²SiO)_{g}SiR¹₃, Formula (II): or

combinations thereof.

In formulae (I) and (II), each R¹ is independently a monovalent organic group free of aliphatic unsaturation and each R² is independently an aliphatically unsaturated organic group. Suitable monovalent organic groups of R¹ include, but are not limited to, alkyl groups having 1 to 20, 1 to 15, 1 to 10, 5 to 20, 5 to 15, or 5 to 10 carbon atoms, e.g. methyl, ethyl, and isomers of propyl, butyl, t-butyl, pentyl, octyl, undecyl, and octadecyl; cycloalkyl groups such as cyclopentyl and cyclohexyl; and aryl groups such as phenyl, tolyl, xylyl, benzyl, and 2-phenylethyl. Each R² is independently an aliphatically unsaturated monovalent organic group, exemplified by alkenyl groups such as vinyl, allyl, butenyl, pentenyl, hexenyl, or heptenyl groups. It is also contemplated that R² may include halogen atoms or halogen groups.

Subscript “d” typically has an average value of at least 0.1, more typically of at least 0.5, still more typically of at least 0.8, and most typically, of at least 2. Alternatively subscript “d” may have an average value ranging from 0.1 to 2000. Subscript “e” may be 0 or a positive number. Further, subscript “e” may have an average value ranging from 0 to 2000. Subscript “f” may be 0 or a positive number. Further, subscript “f” may have an average value ranging from 0 to 2000. Subscript “g” has an average value of at least 0.1, typically at least 0.5, more typically at least 0.8, and most typically, at least 2. Alternatively, subscript “g” may have an average value ranging from 0.1 to 2000.

In various embodiments, the (A) organopolysiloxane is further defined as an alkenyldialkylsilyl end-blocked polydialkylsiloxane which may itself be further defined as vinyldimethylsilyl end-blocked polydimethylsiloxane. The (A) organopolysiloxane may be further defined as a dimethylpolysiloxane capped at one or both molecular terminals with dimethylvinylsiloxy groups; a dimethylpolysiloxane capped at one or both molecular terminals with methylphenylvinylsiloxy groups; a copolymer of a methylphenylsiloxane and a dimethylsiloxane capped at both one or both molecular terminals with dimethylvinylsiloxy groups; a copolymer of diphenylsiloxane and dimethylsiloxane capped at one or both molecular terminals with dimethylvinylsiloxy groups, a copolymer of a methylvinylsiloxane and a dimethylsiloxane capped at one or both molecular terminals with dimethylvinylsiloxy groups; a copolymer of a methylvinylsiloxane and a dimethylsiloxane capped at one or both molecular terminals with dimethylvinylsiloxy groups; a methyl (3,3,3-trifluoropropyl) polysiloxane capped at one or both molecular terminals with dimethylvinylsiloxy groups; a copolymer of a methyl (3,3,3-trifluoropropyl) siloxane and a dimethylsiloxane capped at one or both molecular terminals with dimethylvinylsiloxy groups; a copolymer of a methylvinylsiloxane and a dimethylsiloxane capped at one or both molecular terminals with silanol groups; a copolymer of a methylvinylsiloxane, a methylphenylsiloxane, and a dimethylsiloxane capped at one or both molecular terminals with silanol groups; or an organosiloxane copolymer composed of siloxane units represented by the following formulae: (CH₃)₃SiO_{1/2}, (CH₃)₂ (CH₂═CH)SiO_{1/2}, CH₃SiO_{3/2}, (CH₃)₂SiO_{2/2}, CH₃PhSiO_{2/2} and Ph₂SiO_{2/2}.

The (A) organopolysiloxane may further include a resin such as an MQ resin defined as including, consisting essentially of, or consisting of R^{x}₃SiO_{1/2} units and SiO_{4/2} units, a TD resin defined as including, consisting essentially of, or consisting of R^{x}SiO_{3/2} units and R^{x}₂SiO_{2/2} units, an MT resin defined as including, consisting essentially of, or consisting of R^{x}₃SiO_{1/2} units and R^{x}SiO_{3/2} units, an MTD resin defined as including, consisting essentially of, or consisting of R^{x}₃SiO_{1/2} units, R^{x}SiO_{3/2} units, and R^{x}₂SiO_{2/2} units, or a combination thereof. R^{x} designates any monovalent organic group, for example but is not limited to, monovalent hydrocarbon groups and monovalent halogenated hydrocarbon groups. Monovalent hydrocarbon groups include, but are not limited to, alkyl groups having 1 to 20, 1 to 15, 1 to 10, 5 to 20, 5 to 15, or 5 to 10 carbon atoms, e.g. methyl, ethyl, and isomers of propyl, butyl, t-butyl, pentyl, octyl, undecyl, and octadecyl; cycloalkyl groups such as cyclohexyl; alkenyl groups such as vinyl, allyl, butenyl, and hexenyl; alkynyl groups such as ethynyl, propynyl, and butynyl; and aryl groups such as phenyl, tolyl, xylyl, benzyl, and 2-phenylethyl. In one embodiment, the (A) organopolysiloxane is free of halogen atoms. In another embodiment, the (A) organopolysiloxane includes one or more halogen atoms.

### (B) Cross-Linker:

The (B) cross-linker has an average of at least 2 silicon-bonded hydrogen atoms per molecule and may be further defined as, or include, a silane or a siloxane, such as a polyorganosiloxane. In various embodiments, the (B) cross-linker may include more than 2, 3, or even more than 3, silicon-bonded hydrogen atoms per molecule. The (B) cross-linker may have a linear, branched, or partially branched linear, cyclic, dendrite, or resinous molecular structure. The silicon-bonded hydrogen atoms may be terminal or pendant. Alternatively, the (B) cross-linker may include both terminal and pendant silicon-bonded hydrogen atoms.

In addition to the silicon-bonded hydrogen atoms, the (B) cross-linker may also include monovalent hydrocarbon groups which do not contain unsaturated aliphatic bonds, such as methyl, ethyl, and isomers of propyl, butyl, t-butyl, pentyl, hexyl, heptyl, octyl, decyl, undecyl, dodecyl, or similar alkyl groups e.g. alkyl groups having 1 to 20, 1 to 15, 1 to 10, 5 to 20, 5 to 15, or 5 to 10 carbon atoms; cyclopentyl, cyclohexyl, or similar cycloalkyl groups; phenyl, tolyl, xylyl, or similar aryl groups; benzyl, phenethyl, or similar aralkyl groups; or 3,3,3-trifluoropropyl, 3-chloropropyl, or similar halogenated alkyl group. Preferable are alkyl and aryl groups, in particular, methyl and phenyl groups.

The (B) cross-linker may also include siloxane units including, but not limited to, HR³₂SiO_{1/2}, R³₃SiO_{1/2}, HR³SiO_{2/2}, R³₂SiO_{2/2}, R³SiO_{3/2}, and SiO_{4/2} units. In the preceding formulae, each R³ is independently selected from monovalent organic groups free of aliphatic unsaturation. In various embodiments, the (B) cross-linker includes or is a compound of the formulae:

R³₃SiO(R³₂SiO)ₕ(R³HSiO)ᵢSiR³₃, Formula (III)

R³₂HSiO(R³₂SiO)ⱼ(R³HSiO)ₖSiR³₂H, Formula (IV)

or a combination thereof.

In formulae (III) and (IV) above, subscript “h” has an average value ranging from 0 to 2000, subscript “i” has an average value ranging from 2 to 2000, subscript “j” has an average value ranging from 0 to 2000, and subscript “k” has an average value ranging from 0 to 2000. Each R³ is independently a monovalent organic group. Suitable monovalent organic groups include alkyl groups having 1 to 20, 1 to 15, 1 to 10, 5 to 20, 5 to 15, or 5 to 10 carbon atoms, e.g. methyl, ethyl, and isomers of propyl, butyl, t-butyl, pentyl, octyl, decyl, undecyl, dodecyl, and octadecyl; cycloalkyl such as cyclopentyl and cyclohexyl; alkenyl such as vinyl, allyl, butenyl, and hexenyl; alkynyl such as ethynyl, propynyl, and butynyl; and aryl such as phenyl, tolyl, xylyl, benzyl, and 2-phenylethyl.

The (B) cross-linker may alternatively be further defined as a methylhydrogen polysiloxane capped at both molecular terminals with trimethylsiloxy groups; a copolymer of a methylhydrogensiloxane and a dimethylsiloxane capped at both molecular terminals with trimethylsiloxy groups; a dimethylpolysiloxane capped at both molecular terminals with dimethylhydrogensiloxy groups; a methylhydrogenpolysiloxane capped at both molecular terminals with dimethylhydrogensiloxy groups; a copolymer of a methylhydrogensiloxane and a dimethylsiloxane capped at one or both molecular terminals with dimethylhydrogensiloxy groups; a cyclic methylhydrogenpolysiloxane; and/or an organosiloxane composed of siloxane units represented by the following formulae: (CH₃)₃ SiO_{1/2}, (CH₃)₂HSiO_{1/2}, and SiO_{4/2}; tetra(dimethylhydrogensiloxy) silane, or methyl-tri(dimethylhydrogensiloxy) silane.

It is also contemplated that the (B) cross-linker may be or include a combination of two or more organohydrogenpolysiloxanes that differ in at least one of the following properties: structure, average molecular weight, viscosity, siloxane units, and sequence. The (B) cross-linker may also include a silane. Dimethylhydrogensiloxy-terminated poly dimethylsiloxanes having relatively low degrees of polymerization (DP) (e.g., DP ranging from 3 to 50) are commonly referred to as chain extenders, and a portion of the (B) cross-linker may be or include a chain extender. In one embodiment, the (B) cross-linker is free of halogen atoms. In another embodiment, the (B) cross-linker includes one or more halogen atoms per molecule. It is contemplated that the gel, as a whole, may be free of halogen atoms or may include halogen atoms.

### (C) Hydrosilylation Catalyst:

The (C) hydrosilylation catalyst is not particularly limited and may be any known in the art. In one embodiment, the (C) hydrosilylation catalyst includes a platinum group metal selected from platinum, rhodium, ruthenium, palladium, osmium or iridium, organometallic compounds thereof, or combinations thereof. In another embodiment, the (C) hydrosilylation catalyst is further defined as a fine platinum metal powder, platinum black, platinum dichloride, platinum tetrachloride; chloroplatinic acid, alcohol-modified chloroplatinic acid, chloroplatinic acid hexahydrate; and complexes of such compounds, such as platinum complexes of olefins, platinum complexes of carbonyls, platinum complexes of alkenylsiloxanes, e.g. 1,3-divinyltetramethyldisiloxane, platinum complexes of low molecular weight organopolysiloxanes, for example 1,3-diethenyl-1,1,3,3—tetramethyldisiloxane, complexes of chloroplatinic acid with β-diketones, complexes of chloroplatinic acid with olefins, and complexes of chloroplatinic acid with 1,3-divinyltetramethyldisiloxane.

Alternatively, the (C) hydrosilylation catalyst may be further defined as a rhodium compound, such as those expressed by formulae: RhX₃[(R⁴)₂S]₃; (R⁵₃P)₂Rh(CO)X, (R⁵₃P)₂Rh(CO)H, Rh₂X₂Y₄, H_{f}Rh_{g}(En)ₕClᵢ, or Rh[O(CO)R]₃-j(OH)ⱼ, wherein each X is independently a hydrogen atom, chlorine atom, bromine atom, or iodine atom, each Y is independently a methyl group, ethyl group, or a similar alkyl group, CO, C₈H₁₄, or 0.5 C₈H₁₂; each R⁴ is independently a methyl, ethyl, propyl, or a similar alkyl group; a cycloheptyl, cyclohexyl, cyclopentyl, or a similar cycloalkyl group; or a phenyl, xylyl or a similar aryl group; each R⁵ is independently a methyl group, ethyl group, or a similar alkyl group; phenyl, tolyl, xylyl, or a similar aryl group; methoxy, ethoxy, or a similar alkoxy group, wherein each “En” is ethylene, propylene, butene, hexene, or a similar olefin; subscript “f” is 0 or 1; subscript “g” is 1 or 2; subscript “h” is an integer from 1 to 4; subscript “i” is 2, 3, or 4; and subscript “j” is 0 or 1. Particularly suitable but non-limiting examples of rhodium compounds are RhCl(Ph₃P)₃, RhCl₃[S(C₄H₉)₂]₃, [Rh(O₂CCH₃)₂]₂, Rh(OCCH₃)₃, Rh₂(C₈H₁₅O₂)₄, Rh(C₅H₇O₂)₃, Rh(C₅H₇O₂)(CO)₂, and Rh(CO)[Ph₃P](C₅H₇O₂).

The (C) hydrosilylation catalyst may also be further defined as an iridium group compound represented by the following formulae: Ir(OOCCH₃)₃, Ir(C₅H₇O₂)₃, [Ir(Z)(En)₂]₂, or [Ir(Z)(Dien)]₂ wherein each “Z” is chlorine atom, bromine atom, iodine atom, or a methoxy group, ethoxy group, or a similar alkoxy group; each “En” is ethylene, propylene, butene, hexene, or a similar olefin; and “Dien” is (cyclooctadiene)tetrakis(triphenyl). The (C) hydrosilylation catalyst may also be palladium, a mixture of palladium black and triphenylphosphine. The (C) hydrosilylation catalyst and/or any of the aforementioned compounds may be microencapsulated in a resin matrix or coreshell type structure, or may be mixed and embedded in an thermoplastic organic resin powder, e.g. a methylmethacrylate resin, carbonate resin, polystyrene resin, silicone resin, or similar resin. Typically, the (C) hydrosilylation catalyst is present/utilized in an amount of from 0.01 to 1,000 ppm, alternatively 0.1 to 500 ppm alternatively 1 to 500 ppm, alternatively 2 to 200, alternatively 5 to 150 ppm, based on the total weight of (A) and (B).

### (D) Heated Reaction Product of Iron Acetylacetonate:

The (D) heated reaction product of the iron acetylacetonate (acac) is typically formed by heating the iron acetylacetonate in the presence of oxygen, air, or an inert atmosphere.

Iron acetylacetonate may be further defined as one of, or a mixture of, iron(III) acetylacetonate and/or iron(II) acetylacetonate. Iron(II) acetylacetonate, also known in the art as a 2,4-pentanedione iron(II) derivative, Fe(acac)₂, and ferrous acetylacetonate, has the formula [CH₃COCH═C(O)CH₃]₂Fe, bearing the CAS number of 14024-17-0. Iron(III) acetylacetonate, also known in the art as 2,4-pentanedione iron(III) derivative, Fe(acac)₃, ferric acetylacetonate, tris(a_{c}etylacetonaₜo) iron(III), and iron(III) 2,4-pentanedionate, has the formula Fe(C₅H₇O₂)₃, bearing the CAS number 14024-18-1.

Without intending to be bound by any particular theory, it is believed that the iron acetylacetonate, upon heating, at least partially oxidizes to form iron oxide(s). Moreover, it is also believed that Si—O—Fe bonds may also be formed. It is also believed that, upon heating, all or a portion of the acetylacetonate (ligand) is evaporated. In one embodiment, the iron acetylacetonate reacts with oxygen in the air to oxidize the iron acetylacetonate and form iron oxide. The iron acetylacetonate may form iron oxide and other compounds upon heating.

The iron acetylacetonate, as a whole compound, is present, i.e., added, prior to heating in an amount of from about 0.05 to about 30 or 0.1 to 30, weight percent based on a total weight of (A) and (B). In various embodiments, the iron oxide(s) may be present in an amount of from about 0.05 to about 5, about 0.1 to about 5, about 0.1 to about 1, about 0.05 to about 1, about 1 to about 5, about 2 to about 4, about 2 to about 3, about 5 to about 25, about 10 to about 20, or about 15 to about 20, weight percent based on a total weight of (A) and (B). It is contemplated that less than 100 percent by weight of the iron acetylacetonate may be converted to the iron oxide(s) upon heating. For example, upon heating, some of the iron acetylacetonate may not react, some may form iron oxide(s), some may react to form Si—O—Fe bonds, and/or some may form other compounds not described herein. Alternatively, all or almost all (>85, 90, 95 or 99 wt. %) of the iron acetylacetonate may be converted to one or more forms of iron oxide(s). Percentage conversion may be determined using X-ray scattering and TEM/EDX (Transmission Electron Microscopy/Energy Dispersive X-ray Spectrometry). Without intending to be limited by any particular theory, it is believed that increased presence of acetylacetonate ligands may increase the chance of bubbling and degradation of the gel. Typically, a maximum amount of acetylacetonate is evaporated and/or converted into other species.

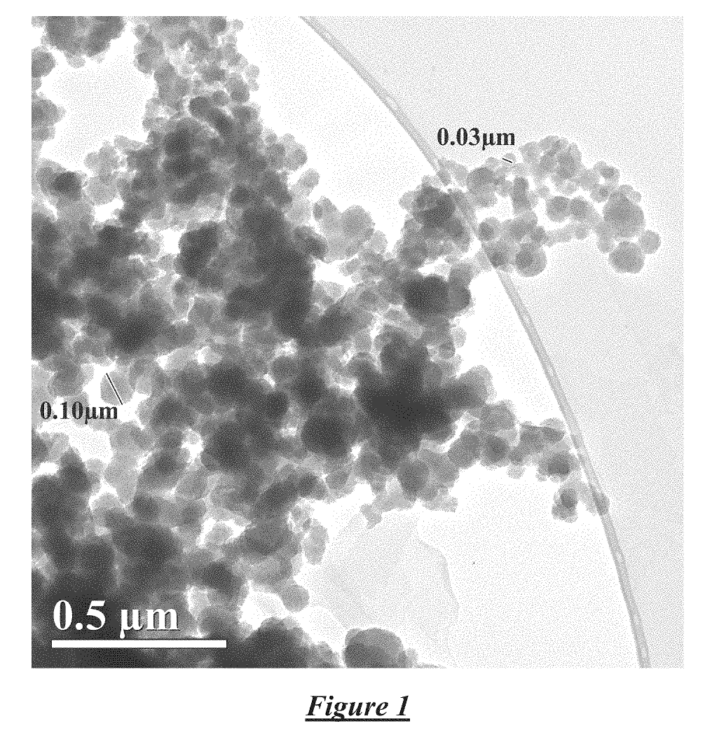

The iron oxide may be further defined as one or more of iron (II) oxide, iron (II,III) oxide, or iron (III) oxide. The iron oxide is not particularly limited relative to particle size. In various embodiments, the iron oxide has an average particle size of less than about 10,000 nm, less than about 5,000 nm, less than about 1,000 nm, less than about 500 nm, less than about 100 nm, less than about 50 nm, or less than about 30 nm. In another embodiment, the iron oxide is further described as nano-sized iron oxide. An electron micrograph of one non-limiting embodiment of iron oxide particles in a polydimethylsiloxane fluid is shown in FIG. 1.

The amount of iron acetylacetonate described above refers to a total weight of the iron acetylacetonate, which is different from the weight of the iron (Fe) itself. The amount of iron (Fe) itself present in the gel and/or present based on a total weight of (A) and (B) or the gel itself is typically from 0.0003 to 0.1, from 0.0005 to 0.1, from 0.003 to 0.05, from 0.005 to 0.03, from 0.0003 to 0.01, from 0.0007 to 0.0075, or from 0.0025 to 0.005, weight percent. In still other embodiments, after incorporating iron acetylacetonate into the composition via component D, the total amount of Fe is present in amount from 40-1000ppm (0.004-0.1 wt %), 0.007-0.07 wt %, or 0.01-0.03 wt %, based on a total weight of (A) and (B) or the gel itself All weights and ranges of weight including and between those set forth above are hereby expressly contemplated for use in various non-limiting embodiments.

In one additional embodiment, (D) is a heated reaction product of iron acetylacetonate formed by heating iron acetylacetonate at 0.1 to 30 wt % in the presence of (E) a silicone fluid to at least 180° C. to form the (D) heated reaction product of iron acetylacetonate before the (D) heated reaction product of iron acetylacetonate is combined with (A), (B), and (C), wherein iron is present in an amount from 0.004 to 0.1 weight percent based on a total weight of (A) and (B), wherein the gel is free of reinforcing fillers.

In another embodiment, (D) is a heated reaction product of iron acetylacetonate formed by heating iron acetylacetonate in the presence of (E) to a temperature of from 180° C. to 200° C. to form (D) before (D) is combined with (A), (B), and (C), e.g. wherein the iron acetylacetonate is combined with (E) in an amount of from about 0.1 to about 30 weight percent based on a total weight of the iron acetylacetonate and (E), before (D) is combined with (A), (B), and (C).

In still another embodiment, (D) is a heated reaction product of iron acetylacetonate formed by heating iron acetylacetonate in the presence of (E) a silicone fluid to at least 180° C. to form the (D) heated reaction product of iron acetylacetonate before the (D) heated reaction product of iron acetylacetonate is combined with (A), (B), and (C), wherein the iron (Fe) of the (D) iron acetylacetonate is present in the gel in an amount of from 0.0003 to 0.1 weight percent based on a total weight of (A) and (B).

### (E) Silicone Fluid:

The gel may also be formed utilizing (E) a silicone fluid. The (E) silicone fluid may be alternatively described as only one of, or as a mixture of, a functional silicone fluid and/or a non-functional silicone fluid. In one embodiment, (E) is further defined as a polydimethylsiloxane, which is not functional. In another embodiment, (E) is further defined as a vinyl functional polydimethylsiloxane. The terminology “functional silicone fluid” typically describes that the fluid is functionalized to react in a hydrosilylation reaction, i.e., include unsaturated groups and/or Si—H groups. However, it is contemplated that the fluid may include one or more additional functional groups in addition to, or in the absence of, one or more unsaturated and/or Si-H groups. In various non-limiting embodiments, (E) is as described in one or more of U.S. Pat. Nos. 6,020,409; 4,374,967; and/or 6,001,918, each of which is expressly incorporated herein by reference. (E) is not particularly limited to any structure or viscosity.

(E) may or may not participate as a reactant with (A) and (B) in a hydrosilylation reaction. In one embodiment, (E) is a functional silicone fluid and reacts with (A) and/or (B) in the presence of (C) and (D). Said differently, the hydrosilylation reaction product may be further defined as the hydrosilylation reaction product of (A), (B), and (E) the functional silicone fluid wherein (A), (B), and (E) react via hydrosilylation in the presence of (C) and (D). In another embodiment, A) and (B) react via hydrosilylation in the presence of (C), (D), and (E) a non-functional silicone fluid.

One or more of (A)-(E) may be combined together to form a mixture and the mixture may further react with remaining components of (A)-(E) to form the gel, with (E) being an optional component in either the mixture or as a remaining component. In other words, any combination of one or more (A)-(E) may react with any other combination of one or more of (A)-(E) so long as the gel is formed.

### Optional Additives:

Any one or more of (A)-(E), or a mixture comprising two or more of (A)-(E), may be independently combined with one or more additives including, but not limited to, inhibitors, spacers, electrical and/or heat conducting and/or non-conducting fillers, reinforcing and/or non-reinforcing fillers, filler treating agents, adhesion promoters, solvents or diluents, surfactants, flux agents, acid acceptors, hydrosilylation stabilizers, stabilizers such as heat stabilizers and/or UV stabilizers, UV sensitizers, and the like. Examples of the aforementioned additives are described in U.S. Prov. App. Ser. No. 61/436,214, filed on Jan. 26, 2011, which is expressly incorporated herein by reference but does not limit the instant disclosure. It is also contemplated that one of more of (A)-(C) or any one or more of the additives may be as described in PCT/US2009/039588, which is also expressly incorporated herein by reference. It is also contemplated that the gel and/or the electronic article of this disclosure may be free of one or more of any of the aforementioned additives.

In various embodiments, any one or more of (A)-(E), a mixture comprising two or more of (A)-(E), the gel itself, and/or any one or more components of the gel, may include or be free of any one or more of the additives described above or below. For example, any one or more of (A)-(E), a mixture comprising two or more of (A)-(E), the gel itself, and/or any one or more components of the gel, may include less than 10, 9, 8, 7, 6, 5, 4, 3, 2, 1, 0.5, 0.1, 0.05, or 0.01, weight percent of any one or more of the additives described above or below, based on a total weight of the appropriate component (A)-(E), mixtures thereof, or the gel itself In various embodiments, any one or more of (A)-(E), a mixture comprising two or more of (A)-(E), the gel itself, and/or any one or more components of the gel, is free of (e.g. includes zero or an technically insignificant amount of) carbon black, as understood by those of skill in the art. In other embodiments, any one or more of (A)-(E), a mixture comprising two or more of (A)-(E), the gel itself, and/or any one or more components of the gel, is free of reinforcing silica.

In other embodiments, any one or more of (A)-(E), a mixture comprising two or more of (A)-(E), the gel itself, and/or any one or more components of the gel, is free of one or more organic carboxylic acids, which may be chosen by one of skill in the art. Examples include, but are not limited to, acetic acid, propanoic acid, butanoic acid, pentanoic acid, hexanoic acid, heptanoic acid, octanoic acid, pelargonic acid, 2-ethylhexanoic acid, and acids which are isomers of the above acids. The organic carboxylic acid may be any known in the art and is not limited to those described above.

In still other embodiments, any one or more of (A)-(E), a mixture comprising two or more of (A)-(E), the gel itself, and/or any one or more components of the gel, is free of metal salts other than the iron acetylacetonate, which may be chosen by one of skill in the art. Non-limiting examples include other acetylacetonates such as nickel acetylacetonate, cerium acetylacetonate, copper acetylacetonate, zinc acetylacetonate, aluminum acetylacetonate, zirconium acetylacetonate, titanium acetylacetonate, tautomers thereof, hydrates and non-hydrates thereof, and the like. The metal salt may be any known in the art and is not limited to those described above.

In the aforementioned embodiments, the terminology “free of” typically describes an amount of zero but may include less than 0.005, 0.001, 0.0005, or 0.0001, weight percent, based on a total weight of the appropriate component (A)-(E), mixtures thereof, or the gel itself.

### Method of Forming the Gel:

Referring back to the method of forming the gel first introduced above, the method typically includes the steps of providing (A), providing (B), providing (C), providing the iron acetylacetonate, and optionally providing (E). Each may be provided independently or in conjunction with one or more of the others.

### (1) Heating the Iron Acetylacetonate to Form (D):

The method also includes the step of (I) heating the iron acetylacetonate to form the (D) heated reaction product of the iron acetylacetonate. The iron acetylacetonate is typically heated at a temperature of at least about 120° C., at least 130° C., at least 140° C., at least 150° C., at least 160° C., at least 170° C., at least 180° C., at least 190° C., or at least 200° C. In various embodiments, the iron acetylacetonate is heated at a temperature of from about 120 to 180, from 130 to 170, from 140 to 160, from 150 to 160, of from 120 to 200, of from 160 to 190, or about 180, ° C. In one embodiment, the iron acetylacetonate is heated to a temperature such that all or almost all (>85, 90, 95 or 99 wt. %) of the acetylacetonate (ligands) evaporates. In another embodiment, the iron acetylacetonate is heated to a temperature that is sufficient to oxidize the iron acetylacetonate to form the iron oxide. The acetylacetonate ligands may evaporate as the iron forms the iron oxide. The iron acetylacetonate may be heated using any heating mechanism including both direct and indirect heating and may be heated in air, oxygen, and/or an inert atmosphere. The time of heating of the iron acetylacetonate is not particularly limited. Several non-limiting embodiments include heating the iron acetylacetonate for times of from 30 minutes and above in the increment of 1 minute to about 120 minutes, for example from 60 to 180 minutes, from 60 to 120 minutes, from 30 to 60 minutes, from 100 to 120 minutes, or from 80 to 100 minutes.

In one embodiment, the iron acetylacetonate is combined with a solvent, e.g. an organic solvent, prior to heating to form (D). The method may further include the step of removing most (e.g. >95 or 99 wt %) or all of the solvent from the iron acetylacetonate prior to the step of heating. The solvent may be removed using heat, vacuum, and/or a sparge.

In various embodiments, the iron acetylacetonate is heated to remove solvent at any suitable temperature in a range above the room temperature to about 200° C., for example a temperature of from 20 to 200, from 30 to 190, from 40 to 180, from 50 to 170, from 60 to 160, from 70 to 150, from 80 to 140, from 90 to 130, from 100 to 120, or from 100 to 110, ° C., with or without application of vacuum and/or sparge. In other embodiments, heat, vacuum, and/or sparge are applied for times of from 1 to 180 minutes, from 5 to 60 minutes, from 5 to 30 minutes, from 15 to 30 minutes, from 15 to 60 minutes, from 15 to 45 minutes, from 60 to 180 minutes, from 60 to 120 minutes, from 30 to 60 minutes, from 100 to 120 minutes, or from 80 to 100 minutes.

The method may include the step of heating the iron acetylacetonate to remove the solvent independently from the step of heating the iron acetylacetonate to form (D). In other words, the iron acetylacetonate may be heated to remove solvent prior to, and at a different temperature and/or for a different time, than the step of heating to form (D). In one embodiment, the iron acetylacetonate is heated to a temperature of about 120° C. to remove solvent and then further heated at a temperature of about 180° C. to form (D). Alternatively, the step of heating to remove the solvent may be the same as heating to form (D).

Alternatively, the iron acetylacetonate may be combined with a functional or non-functional silicone fluid before, during, or after, heating. Once (D) is formed, the functional or non-functional silicone fluid may be utilized with (D) or removed from (D). In one embodiment, (D) is formed in a functional or non-functional silicone fluid and the combination of (D) and the fluid is then utilized to form the gel. The amount of the functional or non-functional silicone fluid used to form (D) may be included in the total amount of silicone fluid described below or may be entirely independent and separate from the amount of silicone fluid described below.

### (II) Combining (A), (B), (C), and (D) to Effect the Hydrosilylation Reaction of (A) and (B):

The method also includes the step of (II) combining (A), (B), (C), and (D) to effect the hydrosilylation reaction of (A) and (B) in the presence of (C) and (D). It is contemplated that (A) and (B) may be heated to effect the hydrosilylation reaction and this heat may provide the heat for the step of (I) heating the iron acetylacetonate to form (D) and/or the step of heating the iron acetylacetonate to remove solvent. It is also contemplated that the step of combining and/or reacting (A) and (B) may include any other step known in the art as utilized during hydrosilylation reactions.

Combining Iron acetylacetonate and (E) the Silicone Fluid:

In various embodiments, the method also includes the step of combining the iron acetylacetonate and (E) to form a mixture. The step of combining may occur before or after heating to form (D). It is contemplated that the mixture itself may be heated to form (D). Alternatively, the iron acetylacetonate and/or (E) may be independently heated and then combined. It is contemplated that the iron acetylacetonate and (E) may be combined together in any order and in any fashion to form the mixture. For example, an entire amount, or a series of portions, of the iron acetylacetonate may be added to (E) or vice versa. The iron acetylacetonate and (E) may be combined using any method known in the art including mixing, stirring, vortexing, etc. Typically, the iron acetylacetonate is added to (E) in an amount such that the iron acetylacetonate is present in an amount of from about 0.01 to about 30, from about 0.5 to about 10, or from about 0.5 to about 5, parts by weight per 100 parts by weight of the mixture of the iron acetylacetonate and (E). Similarly, (E) is typically added in an amount such that (E) is present in an amount of from about 70 to about 99.99, from about 90 to about 99.5, or from about 95 to 99.5, parts by weight per 100 parts by weight of the mixture of the iron acetylacetonate and (E). The iron acetylacetonate and (E) may be heated at any of the aforementioned temperatures and for any of the aforementioned times above.

The iron acetylacetonate and (E) are typically combined together in a reactor to form the mixture. However, the method is not limited to such as step. The iron acetylacetonate and (E) may be combined in any suitable container, reactor, or vessel to form the mixture. Various suitable containers, reactors, and vessels are known in the art.

In one embodiment, the method includes the step of combining (A), (B), and (C) with the mixture of (D) and (E) to effect a hydrosilylation reaction of (A) and (B) in the presence of (C), (D), and (E) to form the gel. This step of combining typically occurs after the mixture of iron acetylacetonate and (E) is heated. Alternatively, (A)-(D) may be combined with (E). It is contemplated that any and all combinations of steps of adding each of (A)-(E) both independently and/or in conjunction with one or more of the others of (A)-(E) may be utilized in this disclosure.

It is also contemplated that (A) and (B) may cure with or in the presence of one of more of the aforementioned additives or other monomers or polymers described above or in any one of the documents incorporated herein by reference. As described above, (E) may or may not participate in the hydrosilylation reaction of (A) and (B). Typically, (A) and (B) are present, and/or reacted, in an amount such that a ratio of silicon-bonded hydrogen atoms to silicon-bonded alkenyl groups is less than about 1.3:1. This ratio may include or may not include any unsaturated and/or Si—H functionality of (E). Alternatively, the ratio may be about 1:1 or less than about 1:1. In still other embodiments, the ratio is less than 0.9:1, 0.8:1, 0.7:1, 0.6:1, or 0.5:1.

### Gel:

Referring now to the gel, the terminology “gel” is well known in the art. The gel is not a liquid and may be described as not an elastomer, not a silicone rubber, or not a vulcanized rubber. In other words, the gel may be described as non-reinforced and may be a loosely and incompletely cross-linked material, or as a weaker material as compared to a rubber.

The hardness is measured and calculated as described below using a TA-23 probe. The gel typically has a hardness of less than about 1500 grams as measured after heat ageing for 1000 hours at 225° C. However, the gel is not limited to such a hardness. In one alternative embodiment, the gel has a hardness of less than about 1500 grams as measured after heat ageing at 225° C. for 500 hours. In other alternative embodiments, the gel has a hardness of less than 1400, 1300, 1200, 1100, 1000, 900, 800, 700, 600, 500, 400, 300, 200, 100, 90, 80, 70, 60, 50, 40, 30, or 20, grams as measured after heat ageing at 225° C. or 250° C. for 250 hours, for 500 hours, or for 1000 hours. In various embodiments, the gel has a hardness of less than 105, less than 100, less than 95, less than 90, less than 85, less than 80, less than 75, less than 70, less than 65, less than 60, less than 55, less than 50, less than 45, less than 40, less than 35, less than 30, less than 25, or less than 20, grams, as measured after heat ageing at 225° C. for 500 hours. It is also contemplated that the hardness of the gel can be measured using different, but similar, heat ageing times and temperatures. The hardness of the gel may or may not initially decrease after heat ageing. It is contemplated that the hardness of the gel may remain lower after heat ageing than before or may eventually increase to a hardness that is greater, but typically only after long periods of time. In various embodiments, these hardness values vary by ±5%, ±10%, ±15%, ±20%, ±25%, ±30%, etc.

The hardness is calculated as the weight required to insert a TA-23 probe into the gel to a depth of 3 mm. More specifically, the method used to calculate hardness utilizes a Universal TA.XT2 Texture Analyzer (commercially available from Texture Technologies Corp., of Scaresdale, NY) or its equivalent and a TA-23 (0.5 inch round) probe. The Texture Analyzer has a force capacity of 55 lbs and moves the probe at a speed of 1.0 mm/s. The Trigger Value is 5 grams, the Option is set to repeat until count and to set count to 5, the Test Output is Peak, the force is measured in compression, and the container is a 4 oz wide-mouth, round glass bottle. All measurements are made at 25° C.±5° C. and 50%±4% relative humidity. Even more specifically, samples of the gel are prepared, cured, cooled to room temperature (25° C.±5° C.), and stabilized at room temperature for at least 0.5 hours, for 2 to 3 hours, or until a stable hardness is reached. The sample is then positioned on the test bed directly under the probe. The Universal TA.XT2 Texture Analyzer is then programmed with the aforementioned specific parameters according to the manufacturer's operating instructions. Five independent measurements are taken at different points on the surface of the gel. The median of the five independent measurements are reported. The test probe is wiped clean with a soft paper towel after each measurement is taken. The repeatability of the value reported (i.e., the maximum difference between two independent results) should not exceed 6 g at a 95% confidence level. Typically, the thickness of the sample is sufficient to ensure that when the sample is compressed, the force measurement is not influenced by the bottom of the bottle or the surface of the test bed. When performing measurements, the probe is typically not within 0.5 inch of the side of the sample.

The combination of (A) to (D), and optionally (E), before reaction to form the gel, typically has a viscosity less than about 100,000, 75,000, 50,000, 25,000, or 10,000, cps measured at 25° C. using a Brookfield DV-II+ cone and plate viscometer with spindle CP-52 at 50 rpm. In various embodiments, the combination of (A) to (D), (and optionally (E)) before reaction to form the gel, has a viscosity of less than 9,500, less than 9,000, less than 8,500, less than 8,000, less than 7,500, less than 7,000, less than 6,500, less than 6,000, less than 5,500, less than 5,000, less than 4,500, less than 4,000, less than 3,500, less than 3,000, less than 2,500, less than 2,000, less than 1,500, less than 1,000, less than 500, less than 400, less than 300, less than 200, less than 100, less than 90, less than 80, less than 70, less than 60, less than 50, less than 40, less than 30, less than 20, or less than 10, cps measured at 25° C. using a Brookfield DV-II+ cone and plate viscometer with spindle CP-52 at 50 rpm.

In other embodiments, the gel can be described as non-opaque and may be seen through. For example, the gel may allow various amounts of light to pass through and may be visually transparent or semi-transparent, as is judged by one of skill in the art. For example, heating to (uniformly) disperse the Fe(acac)₃ into a PDMS fluid concentrate may contribute to the transparency of the gel. In one embodiment, the gel approaches or is water white in color, as is known in the art.

### Electronic Article:

The instant disclosure also provides an electronic article (hereinafter referred to as an “article.”) The article may be a power electronic article. The article includes an electronic component and the gel disposed on the electronic component. The gel may be disposed on the electronic component such that the gel encapsulates, either partially or completely, the electronic component. Alternatively, the electronic article may include the electronic component and a first layer. The gel may be sandwiched between the electronic component and the first layer, may be disposed on and in direct contact with the first layer, and/or on and in direct contact with the electronic component. If the gel is disposed on and in direct contact with the first layer, the gel may still be disposed on the electronic component but may include one or more layers or structures between the gel and the electronic component. The gel may be disposed on the electronic component as a flat member, a hemispherical nubbin, a convex member, a pyramid, and/or a cone. The electronic component may be further defined as a chip, such as a silicon chip or a silicon carbide chip, one or more wires, one or more sensors, one or more electrodes, and the like.

The electronic article is not particularly limited and may be further defined as an insulated gate bipolar transistor (IGBT), a rectifier such as a Schottky diode, a PiN diode, a merged PiN/Schottky (MPS) rectifier and Junction barrier diode, a bipolar junction transistors (BJTs), a thyristor, a metal oxide field effect transistor (MOSFET), a high electron mobility transistor (HEMT), a static induction transistors (SIT), a power transistor, and the like. The electronic article can alternatively be further defined as power modules including one of more of the aforementioned devices for power converters, inverters, boosters, traction controls, industrial motor controls, power distribution and transportation systems. The electronic article can alternatively be further defined as including one or more of the aforementioned devices.

In addition, the first layer is not particularly limited and may be further independently defined as a semiconductor, a dielectric, metal, plastic, carbon fiber mesh, metal foil, a perforated metal foil (mesh), a filled or unfilled plastic film (such as a polyamide sheet, a polyimide sheet, polyethylene naphthalate sheet, a polyethylene terephthalate polyester sheet, a polysulfone sheet, a polyether imide sheet, or a polyphenylene sulfide sheet), or a woven or nonwoven substrate (such as fiberglass cloth, fiberglass mesh, or aramid paper). Alternatively, the first layer may be further defined as a semiconductor and/or dielectric film.

The disclosure also provides a method of forming the electronic article. The method may include one or more of the aforementioned steps of forming the gel, the step of providing the gel, and/or the step of providing the electronic component. Typically, the method includes the step of applying (A)-(D) and optionally (E) onto the electronic component and reacting (A) and (B) in the presence of (C) and (D) and optionally (E) to form the gel on the electronic component under the condition sufficient to form the gel without damaging the component. The gel may be formed on the electronic component. Alternatively, the gel may be formed apart from the electronic component and subsequently be disposed on the electronic component.

### EXAMPLES

A series of gels (Gels 1-6) are formed according to this disclosure. A series of comparative gel (Comparative Gels 1-4) is also formed but do not represent this disclosure. Each of the Gels 1-6 and the Comparative Gels 1-5 are evaluated to determine initial hardness and hardness after heat ageing. The compositions used to form each of the Gels and the results of the aforementioned evaluations are shown in Table 1 below.

### Heating of Iron(III) Acetylacetonate to Form (D) for Use in Gels 1 and 2:

200 g of SFD119 fluid (Dow Corning, vinyl terminated polydimethylsiloxane, as (E)) is introduced into a 500-ml flask equipped with a mechanical stirrer, thermometer, gas inlet and outlet. 4 g (2% by weight of SFD119) of iron(III) acetylacetonate (Fe(acac)3, Aldrich, 97%)) as a solution in 16 g of dry tetrahydrofuran (THF)) is injected into the reactor to form a maroon-colored, uniform but cloudy dispersion. This dispersion is heated to 120° C. with continuous stirring while purging N₂ through the flask to remove the THF (solvent). After about 15 min at 120° C., the purging gas is changed to air at a flow rate of 3 gallons/hour. The dispersion is stirred at a speed of 450 rpm and the temperature is increased to 180° C. The temperature is held at 180±2° C. for 80 minutes to form (D) and then cooled to room temperature. The final product is a uniformly brown liquid with a similar viscosity to SFD119. This liquid also includes Si—O—Fe bonds as determined using an FT-IR spectrometer.

### Heating of Iron(III) Acetylacetonate to Form (D) for Use in Gels 3-6:

200 g of SFD119 fluid (Dow Corning, vinyl terminated polydimethylsiloxane, as (E)) is introduced into a 500-ml flask equipped with a mechanical stirrer, thermometer, gas inlet and outlet. 6 g (3% by weight of SFD119) of iron(III) acetylacetonate (Fe(acac)₃, Aldrich, 97%)) as a solution in 24 g of dry tetrahydrofuran (THF)) is injected into the reactor to form a maroon-colored, uniform but cloudy dispersion. This dispersion is heated to 120° C. with continuous stirring while purging N₂ through the flask to remove the THF (solvent). After about 20 min at 120° C., the purging gas is changed to air at a flow rate of 3 gallons/hour. The dispersion is stirred at a speed of 450 rpm and the temperature is increased to 180° C. The temperature is held at 180±2° C. for 100 minutes to form (D) and then cooled to room temperature. The final product is a uniformly brown liquid with a similar viscosity to SFD119. This liquid also includes Si—O—Fe bonds as determined using an FT-IR spectrometer.

### Formation of Gels 1-6:

To form these Gels, equal weight parts of Part A and Part B are mixed and de-aired to form a mixture. The mixture is then poured into a glass cup and cured at 150° C. for one hour to form the Gels. Subsequently, the Gels are cooled and initial hardness is measured pursuant to the methods described in detail above. Then, the Gels are heat aged and again evaluated for hardness after heat ageing for 1000 hours at 225° C. In Table 1, all weight percentages in Part A are based on a total weight of Part A. All weight percentages in Part B are based on a total weight of Part B. The values for gel hardness in all tests below represent the average (mean) of 5 independent measurements of the respective Gel. Relative to Gels 1 and 2, these gels are prepared using a separate Component (D) which has a slightly lower Fe(acac)₃ loading that for the other gels.

TABLE 1

| | Gel 1 | Gel 2 | Gel 3 | Gel 4 | Gel 5 | Gel 6 |
|---|---|---|---|---|---|---|
| Part A | | | | | | |
| (A) | ~90 | ~90 | ~90 | ~90 | ~90 | ~90 |
| Organopolysiloxane | wt % | wt % | wt % | wt % | wt % | wt % |
| (C) Hydrosilylation | ~40 | ~40 | ~40 | ~40 | ~40 | ~40 |
| Catalyst | ppm | ppm | ppm | ppm | ppm | ppm |
| (D) Heated | ~0.1 | ~0.2 | ~0.5 | ~1 | ~1.5 | ~2 |
| Reaction Product of | wt % | wt % | wt % | wt % | wt % | wt % |
| Iron | | | | | | |
| Acetylacetonate in | | | | | | |
| SFD119 fluid | | | | | | |
| (E) Silicone Fluid | ~10 | ~10 | ~10 | ~10 | ~10 | ~10 |
| Added Independent | wt % | wt % | wt % | wt % | wt % | wt % |
| of (D) | | | | | | |
| Part B | | | | | | |
| (A) | ~88 | ~88 | ~88 | ~88 | ~88 | ~88 |
| Organopolysiloxane | wt % | wt % | wt % | wt % | wt % | wt % |
| (B) Cross-Linker | ~1.6 | ~1.6 | ~1.6 | ~1.6 | ~1.6 | ~1.6 |
| | wt % | wt % | wt % | wt % | wt % | wt % |
| (E) Silicone Fluid | ~10% | ~10% | ~10% | ~10% | ~10% | ~10% |
| Inhibitor | ~0.07 | ~0.07 | ~0.07 | ~0.07 | ~0.07 | ~0.07 |
| | wt % | wt % | wt % | wt % | wt % | wt % |
| Total Gel | | | | | | |
| Amount of Iron | 0.0003 | 0.0007 | 0.0025 | 0.005 | 0.0075 | 0.01 |
| (Fe) | wt % | wt % | wt % | wt % | wt % | wt % |
| Initial Hardness | ~27 | ~22 | ~43 | ~40 | ~50 | ~37 |
| Prior to | | | | | | |
| Heat Ageing (g) | | | | | | |
| Final Hardness | ~1757 | ~1693 | ~714 | ~262 | ~194 | ~175 |
| After Heat Ageing | | | | | | |
| (g) | | | | | | |

The (A) Organopolysiloxane is a dimethylvinylsiloxy terminated polydimethylsiloxane.

The (B) Cross-Linker is a trimethylsiloxy terminated dimethylmethylhydrogen siloxane.

The (C) Hydrosilylation Catalyst is a 1,3-divinyltetrmethyl disiloxane complex of platinum.

The (D) Heated Reaction Product of Iron Acetylacetonate is as described above. The weights of (D) set forth in the Table above include both the weight of the heated reaction product of iron acetylacetonate itself and the silicone fluid in which the heated reaction product is dispersed

The (E) Silicone Fluid is Dow Corning 200F silicone fluid. The weights of (E) set forth in the Table above are the weights of Dow Corning 200F silicone fluid that are utilized independently from any weight of silicone fluid utilized in (D).

The Inhibitor is tetramethyl tetravinyl cyclotetra siloxane.

The amount of iron (Fe) set forth in the table above is the calculated weight percent of elemental iron based on a total weight of the gels formed from reacting Parts A and B above.

### Formation of Comparative Gels 1A-5B:

Comparative Gels 1A-5B are formed using the same procedure and generally the same chemistry as Gels 1-6 above. However, Comparative Gels 1A-5B differ from Gels 1-6 as follows:

Comparative Gel 1A does not utilize any iron acetylacetonate or any (D) heated reaction product of any iron acetylacetonate.

Comparative Gel 1B utilizes the same weight percent of the iron(III) acetylacetonate that is described above relative to Gel 1, except that no heat is applied in this example. Accordingly, no (D) heated reaction product of iron acetylacetonate is utilized to form Comparative Gel 1B.

Comparative Gel 1C utilizes the same weight percent of the iron(III) acetylacetonate that is described above relative to Gel 4, except that no heat is applied in this example. Accordingly, no (D) heated reaction product of iron acetylacetonate is utilized to form Comparative Gel 1C.

Comparative Gel 2A utilizes zirconium acetylacetonate in place of iron(III) acetylacetonate in a weight percent that is described above relative to Gel 1C, except that no heat is applied in this example. Accordingly, no heated reaction product of zirconium acetylacetonate is utilized to form Comparative Gel 2A.

Comparative Gel 2B utilizes zirconium acetylacetonate in place of iron(III) acetylacetonate in a weight percent that is described above relative to Gel 4 and heated to form Comparative Gel 2B.

Comparative Gel 3A utilizes aluminum acetylacetonate in place of iron(III) acetylacetonate in a weight percent that is described above relative to Gel 1C, except that no heat is applied in this example. Accordingly, no heated reaction product of aluminum acetylacetonate is utilized to form Comparative Gel 3A.

Comparative Gel 3B utilizes aluminum acetylacetonate in place of iron(III) acetylacetonate in a weight percent that is described above relative to Gel 4 and heated to form Comparative Gel 3B.

Comparative Gel 4A utilizes copper acetylacetonate in place of iron(III) acetylacetonate in a weight percent that is described above relative to Gel 1C, except that no heat is applied in this example. Accordingly, no heated reaction product of copper acetylacetonate is utilized to form Comparative Gel 4A.

Comparative Gel 4B utilizes copper acetylacetonate in place of iron(III) acetylacetonate in a weight percent that is described above relative to Gel 4 and heated to form Comparative Gel 4B.

Comparative Gel 5A utilizes cerium acetylacetonate in place of iron(III) acetylacetonate in a weight percent that is described above relative to Gel 1C, except that no heat is applied in this example. Accordingly, no heated reaction product of cerium acetylacetonate is utilized to form Comparative Gel 5A.

Comparative Gel 5B utilizes cerium acetylacetonate in place of iron(III) acetylacetonate in a weight percent that is described above relative to Gel 4 and heated to form Comparative Gel 5B.

The results of the gel hardness evaluations are set forth in Table 2 below. The values for gel hardness set forth in all tests below represent the average (mean) of 5 independent measurements of the respective Gel, as determined using the procedure described above.

TABLE 2

| | Comp. | Comp. | Comp. | Comp. | Comp. | |
|---|---|---|---|---|---|---|
| | Gel 1A | Gel 1B | Gel 1C | Gel 2A | Gel 2B | |
| Initial Hardness Prior | 89 | 61^{(a)} | 60 | 100 | 26 | |
| to Heat Ageing (g) | | | | | | |
| Final Hardness After | Cracked/ | 3,468/750 hr, | 670 | Cracked/ | Cracked/ | |
| Heat Ageing (g) | 24 hr | cracked | 200 hr | 500 hr | | |
| | Comp. | Comp. | Comp. | Comp. | Comp. | Comp. |
| | Gel 3A | Gel 3B | Gel 4A | Gel 4B | Gel 5A | Gel 5B |
| Initial Hardness Prior | 107 | 90^{(a)} | 55 | 76 | 98^{(a)} | 78 |
| to Heat Ageing (g) | | | | | | |
| Final Hardness | Cracked/ | Cracked/ | 2,110 | 1,799 | N/A^{(b)} | N/A^{(b)} |
| After Heat Ageing (g) | 750 hr | 24 hr | | | | |

^{(a)}This gel sample generated large bubbles inside and on the surface at 225° C. by 24 hours.
^{(b)}Not available data. These two gel samples became into liquid and then cracked at 225° C. by 750 hours with significant weight loss.

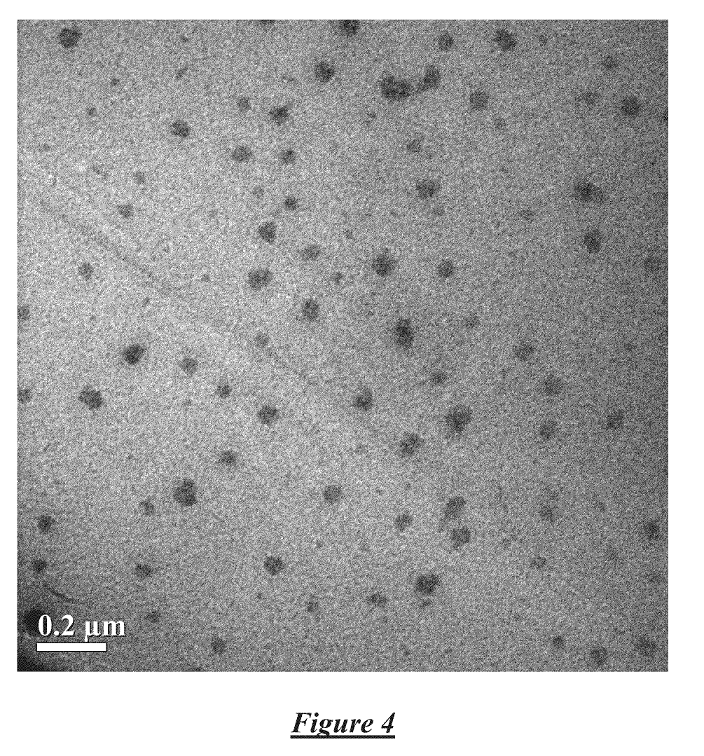

The data above establishes that the Comparative Gels do not exhibit the same unexpected decrease in hardness after heat ageing as Gels 1-6 of this disclosure. The iron(III) acetylacetonate in Gels 1-6 of this disclosure (see FIG. 4) allows these gels to maintain low modulus (i.e., low hardness) properties even after extensive heat ageing. Maintenance of the low modulus properties allows the gel to be utilized in an electronic article with minimal impact on electrodes and electrical wires after heat ageing.

### Evaluation of Forms of Iron Oxide:

Additional samples of Gel 6 are further evaluated to determine the effect of various forms of iron oxide on the hardness of the gels and to evaluate whether the iron(III) acetylacetonate used in Gel 6 is converted, at least in part, to iron oxide in-situ after heating. More specifically, multiple samples of Gel 6 are formulated and evaluated.

In a first series, samples of Gel 6 are formulated as described above including the iron(III) acetylacetonate heated in the (E) silicone fluid. The (D) heated reaction product formed in these samples is illustrated in the electron micrograph of FIG. 1.

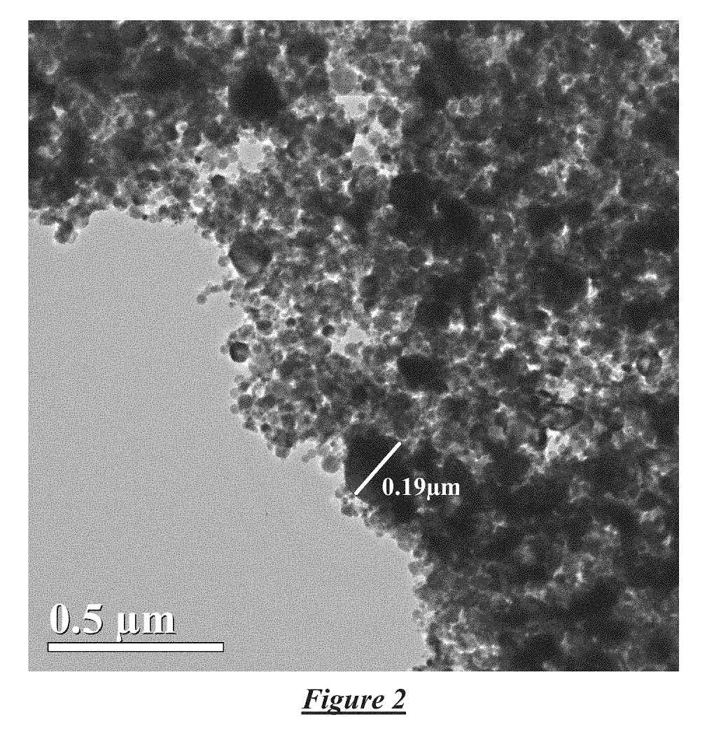

In a second series, samples of Gel 6 are formulated as described above except that nano-sized Fe₂O₃, as purchased from Sigma Aldrich and having a particle size of less than 50 nm, is utilized in place of the iron(III) acetylacetonate. Said differently, no (D) heated reaction product is used in this second series. Instead, the nano-sized Fe₂O₃ is substituted for the (D) heated reaction product. The nano-sized Fe₂O₃ used in this second series is illustrated in the electron micrograph of FIG. 2.

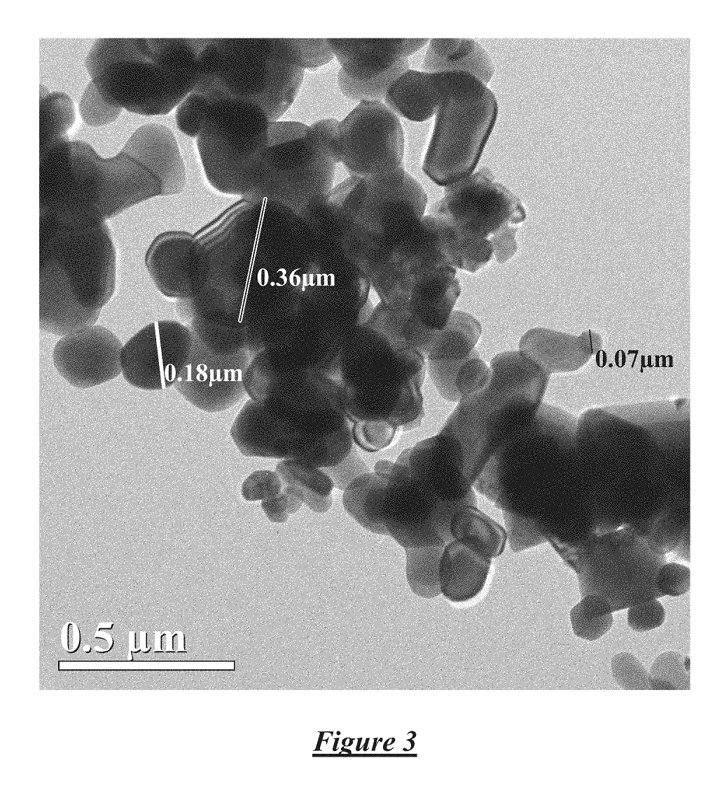

In a third series, samples of Gel 6 are formulated as described above except that micro-sized Fe₂O₃, as purchased from Sigma Aldrich and having a particle size of less than 5 μm, is utilized in place of the iron(III) acetylacetonate. Said differently, no (D) heated reaction product is used in this third series. Instead, the micro-sized Fe₂O₃ is substituted for the (D) heated reaction product. The micro-sized Fe₂O₃ used in this third series is illustrated in the electron micrograph of FIG. 3.

More specifically, electron micrographs of the various particles of Fe₂O₃ are shown as FIGS. 1-3, wherein FIG. 1 illustrates Fe₂O₃ from heated iron(III) acetylacetonate of the first series, FIG. 2 illustrates nano-sized Fe₂O₃ of the second series, and FIG. 3 illustrates micro-sized Fe₂O₃ of the third series. FIG. 4 is a representative transmission electron micrograph (TEM) image of the (D) heated reaction product of iron acetylacetonate (Fe (acac)) (i.e., nanoparticles) dispersed in Gel 4.

Samples of each series are evaluated to determine hardness after no ageing (time zero), after 70 hours of heat ageing at 225° C., after 250 hours of heat ageing at 225° C., after 500 hours of heat ageing at 225° C., and after 1000 hours of heat ageing at 225° C. The results of the gel hardness evaluations are shown below. The values for gel hardness in all tests below represent the average (mean) of 5 independent measurements of the respective sample.

| Hours of | First Series | Second | Third |
|---|---|---|---|
| Heat | ((D) Heated Reaction | Series | Series |
| Ageing at | Product of Iron | (Nano- | (Micro- |
| 225° C. | Acetylacetonate) | Fe₂O₃) | Fe₂O₃) |
| 0 Hrs | 37 grams | 34 grams | 35 grams |
| 70 Hrs | 26 grams | 22 grams | 47 grams |
| 250 Hrs | 36 grams | 32 grams | 334 grams |
| 500 Hrs | 64 grams | 116 grams | 959 grams |
| 1000 Hrs | 156 grams | 527 grams | 1503 grams |

The data above establishes that the Gels of this disclosure have improved heat ageing as compared to comparative gels that are chemically identical except for the iron oxide differences. This data makes it clear that mere addition of Fe₂O₃ to gel compositions does not achieve the same results as this disclosure which heats the iron acetylacetonate to form the (D) heated reaction product and then uses the (D) heated reaction product to form the gels.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1-7. (canceled)

8. A gel that has improved thermal stability and that is the hydrosilylation reaction product of:
(A) an organopolysiloxane having an average of at least 0.1 silicon-bonded alkenyl group per molecule; and
(B) a cross-linker having an average of at least 2 silicon-bonded hydrogen atoms per molecule;
wherein (A) and (B) react via hydrosilylation in the presence of;
(C) a hydrosilylation catalyst, and
(D) a heated reaction product of iron acetylacetonate formed by heating iron acetylacetonate in the presence of (E) a silicone fluid to at least 180° C. to form said (D) heated reaction product of iron acetylacetonate before said (D) heated reaction product of iron acetylacetonate is combined with (A), (B), and (C), wherein the iron (Fe) of said (D) iron acetylacetonate is present in said gel in an amount of from 0.0003 to 0.1 weight percent based on a total weight of (A) and (B);
wherein said gel is free of reinforcing fillers; and
wherein said gel is free of organic carboxylic acids.

9. The gel according to claim 8 having a hardness of less than about 1500 grams as measured after heat ageing for 1000 hours at 225° C. that is calculated as a weight required to insert a TA-23 probe into the gel to a depth of 3 mm.

10. (canceled)

11. The gel according to claim 8 wherein (E) is a non-functional silicone fluid.

12. The gel according to claim 8 wherein said hydrosilylation reaction product is a hydrosilylation reaction product of (A), (B), and (E) a functional silicone fluid and wherein (A), (B), and (E) react via hydrosilylation in the presence of (C) and (D).

13. The gel according to claim 8 wherein, prior to introduction to said gel, said iron acetylacetonate is combined with (E) said silicone fluid in an amount of from about 0.1 to about 30 weight percent based on a total weight of said iron acetylacetonate and (E).

14. The gel according to claim 13 wherein said iron acetylacetonate and (E) are heated to a temperature of from 180° C. to 200° C.

15-22. (canceled)

23. The gel according to claim 8 wherein said iron (Fe) of said iron acetylacetonate is present in said gel an amount of from 0.003 to 0.05 weight percent based on a total weight of (A) and (B).

24. The gel according to claim 8 wherein said iron (Fe) of said iron acetylacetonate is present in said gel in an amount of from 0.005 to 0.03 weight percent based on a total weight of (A) and (B).

25. The gel according to claim 8 that is free of carbon black.

26. The gel according to claim 8 that is free of metal salts other than said iron acetylacetonate.

27. A gel that has improved thermal stability and that is the hydrosilylation reaction product of:
(A) an organopolysiloxane having an average of at least 0.1 silicon-bonded alkenyl group per molecule; and
(B) a cross-linker having an average of at least 2 silicon-bonded hydrogen atoms per molecule;
wherein (A) and (B) react via hydrosilylation in the presence of;
(C) a hydrosilylation catalyst,
(D) a heated reaction product of iron acetylacetonate formed by heating iron acetylacetonate in the presence of (E) a non-functional silicone fluid to a temperature of from 180° C. to 200° C. to form said (D) heated reaction product of iron acetylacetonate before said (D) heated reaction product of iron acetylacetonate is combined with (A), (B), and (C),
wherein said iron acetylacetonate is combined with said (E) non-functional silicone fluid in an amount of from about 0.1 to about 30 weight percent based on a total weight of said iron acetylacetonate and (E), before said (D) heated reaction product of iron acetylacetonate is combined with (A), (B), and (C),
wherein iron (Fe) of said iron acetylacetonate is present in said gel in an amount of from 0.0003 to 0.1 weight percent based on a total weight of (A) and (B);
wherein said gel is free of reinforcing fillers comprising carbon black;
wherein said gel is free of organic carboxylic acids; and
wherein said gel is free of metal salts other than said iron acetylacetonate.

28. The gel according to claim 27 having a hardness of less than about 1500 grams as measured after heat ageing for 1000 hours at 225° C. that is calculated as a weight required to insert a TA-23 probe into the gel to a depth of 3 mm.
